(19) United States
(12) Patent Application Publication
(10) Pub. No.: US 2010/0184914 A1
(43) Pub. Date: Jul. 22, 2010

(54) BLOCKED ISOCYANATE CONTAINING EMULSION COMPOSITION, PRODUCTION METHOD THEREOF, BAKING PAINT OR ADHESIVE COMPOSITION

(75) Inventors: Takaki Jono, Kanagawa (JP); Naotaka Izumi, Kanagawa (JP); Iku Ohki, Kanagawa (JP); Mitsuru Chiba, Kanagawa (JP)

Correspondence Address: GREENBLUM & BERNSTEIN, P.L.C., 1950 ROLAND CLARKE PLACE, RESTON, VA, 20191, US

(73) Assignee: NIPPON POLYURETHANE INDUSTRY CO., LTD., Tokyo (JP)

(21) Appl. No.: 12/377,224

(22) PCT Filed: Aug. 7, 2007
(86) PCT No.: PCT/JP2007/000842

§ 371 Date: Apr. 14, 2009

(30) Foreign Application Priority Data
Aug. 18, 2006 (JP) 2006-223683

(51) Int. Cl. C08L 75/04

(52) U.S. Cl. 524/591

(57) ABSTRACT

[Problem] To improve the previous aqueous one-component coating polyurethane emulsion among the aqueous one-component type polyurethane resin coating agents utilizing the blocked isocyanate compounds, in order to improve aqueous dispersibility and the storage stability of the emulsion as well as various coating performances of the coating appearing around the dissociation temperature of the blocking groups.

[Means for Solving the Problem] A blocked isocyanate containing emulsion composition prepared by; reacting organic polyisocyanate (a1) with nonionic polar group containing high molecular weight polyol (a2) thereafter blocking isocyanate groups with a blocking agent (C) to form a blocked polyisocyanate component (A); subsequently reacting, in the above reaction mixture, organic polyisocyanate (b1), high molecular weight polyol (b2), and anionic low molecular weight glycol containing COOH group (b3) to form carboxyl group containing isocyanate-terminated urethane prepolymer (B); neutralizing the carboxyl groups in aforementioned reaction mixture by a neutralizing agent (D); then emulsifying resulted reaction mixture in water; and further then subjecting resulted emulsion to chain extension reaction to prepare a highly crosslinkable polyurethane resin.

### FIELD OF THE INVENTION

The present invention relates to a blocked isocyanate containing emulsion composition and production method thereof, and a baking paint and adhesive compositions, and particularly relates to the emulsion composition and the production method of the emulsion composition by particular steps, in which the emulsion forms core-shell structures with its particle size distribution made smaller and narrower while the emulsion composition has an excellent storage stability even at the temperature not less than 35 degrees Celsius and an excellent property for coating agents.

Further present invention relates to an aqueous one-component baking type paint and adhesive compositions that has an excellent coating property and the like.

### BACKGROUND ART

Polyurethane resin compositions have been widely used as coating and adhesive agents, particularly as paints in a variety of industrial fields such as automobiles, building materials, electric household appliances, woodworks, etc., because of their excellent physical properties, economical benefits, formability as well as applicability.

Recently, aqueous compositions that avoid the use of organic solvents have particular importance in view of environmental preservation and working safety, and have become more and more popular in use when compared with the organic solvent based compositions because of their economical advantage owing to non-use of the organic solvent. However, in aqueous polyurethane resin coating agent, various material properties thereof such as durability and solvent resistance are generally poor when compared with those of organic solvent based coating agents. So efforts for improvement have been continued so as to attain physical properties nearly equivalent to those of organic solvent based coating agents.

As one of the improvement methods, an aqueous one-component polyurethane emulsion which includes urethane pre-polymer being introduced with carboxyl groups subjected to neutralization thereof to provide aqueous dispersibility followed by emulsifying in water to subject chain extension and another urethane pre-polymer immiscible with water was disclosed (refer to Patent Literature 1). However, the entire coating properties of the disclosed coating agents were still insufficient.

As another advantageous method for improvements, an aqueous one-component type polyurethane resin coating agent which utilizes so called blocked isocyanate compounds (refer to, e.g. see Patent Literature 2) has been well known. Such kind of coating agents is so-called an one-component baking type coating agent in which isocyanate groups are blocked so as to inhibit progression of the cross-linking and curing at room temperature and the coating layer thereof may be cured upon heating due to the dissociation of blocking groups from isocyanate groups. The above mentioned coating agents provide with various performances such as water resistance and solvent resistance, or durability and adherence and the like being superior to those of the coating film prepared from the room temperature drying type. In order to further improve storage stability etc., an aqueous baking type blocked polyurethane coating agent, which use an isocyanate compound having nonionic hydrophilic group together with an ionic surfactant, has been well known (refer to Patent Literature 3). However, these aqueous blocked isocyanate containing polyurethane coating agents of baking type are still insufficient in some properties such as durability and solvent resistance as well as impact resistance and gloss property when compared with those of organic solvent based one, and water dispersability and storage stability thereof are still insufficient.

Aqueous one-component coating polyurethane emulsions being prepared by: mixing carboxyl group containing isocyanate-terminated urethane prepolymer and non-anionic (nonionic) polyisocyanate; blocking the isocyanate groups in a mixture by a blocking agent; neutralizing carboxyl groups thereof; emulsifying in water; and then subjecting to chain extension reaction by diamine was disclosed (Patent Literatures 4 and 5). These polyurethane emulsions exhibited improved storage stability, water resistance, solvent resistance, etc. of the film thereof. However, since the blocked isocyanates were beforehand added in the aqueous dispersed resin, amounts of the isocyanate groups being effective during thermal dissociation of the blocking group were restricted, it was still difficult to say that the properties for the coating or the adhesive agent were sufficiently obtained.

Patent Literature 1: Japanese Patent Laid-Open Publication No. H07-188371 (Abstract, and paragraphs 0010 and 0015)

Patent Literature 2: Published Japanese Translation No. 2005-522559 of the PCT International Publication (Abstract, and claim 1 in the scope of claims)

Patent Literature 3: Japanese Patent Laid-Open Publication No. H10-330454 (Abstract, and paragraph 0018)

Patent Literature 4: Japanese Patent Laid-Open Publication No. 2005-154674 (Abstract)

Patent Literature 5: Japanese Patent Laid-Open Publication No. 2005-247897 (Abstract)

### DISCLOSURE OF THE INVENTION

### Problems to be Solved by the Invention

Among the aqueous one-component type polyurethane resin coating agents utilizing the blocked isocyanate compounds, the prior art aqueous one component coating polyurethane emulsion, which was prepared by mixing the non-anionic (nonionic) polyisocyanate with the carboxyl group containing isocyanate-terminated urethane prepolymer; blocking the isocyanate groups in the mixture with the blocking agent; neutralizing the carboxyl groups in the mixture; emulsifying in water; and then subjecting to chain extension reaction by the diamine, is the prior invention filed by the same assignee. Since the aforementioned aqueous one-component type coating polyurethane emulsion included beforehand the blocked isocyanates and then the amounts of the isocyanate groups being effective during thermal dissociation of the blocking group was restricted. Also the storage stability at the temperature not less than 35 degrees Celsius was not sufficient yet. Hence, an object of the present invention is to improve the previous aqueous one-component coating polyurethane emulsion in order to improve aqueous dispersibility and the storage stability of the emulsion as well as various coating performances of the coating appearing around the dissociation temperature of the blocking groups.

### Means for Solving Problem

The inventors have aimed to overcome the above problems of the prior inventions and have improved the previous aqueous one-component coating polyurethane emulsion in order to improve the aqueous dispersibility and the storage stability of the emulsion as well as various coating performances of the coating appearing around the dissociation temperature of the blocking groups by practical experimental examinations through try and error in various viewpoints such as an embodiment for containing the block isocyanate in the aqueous dispersion resin, an embodiment for providing aqueous dispersibility functions, selections and combinations of various reactive materials, reaction conditions for urethane-formation reaction, etc. as well as conditions for emulsification to water and for the chain extension etc.

In the course of the above-described examination, in order to further improve the aqueous dispersibility and the storage stability of the emulsion as well as various coating performances of the coating, the inventors have found an completed the present invention characterized mainly by forming blocked isocyanate through blocking of nonionic polar group containing isocyanate, synthesizing in situ carboxyl group containing isocyanate-terminated urethane prepolymer, and then subjecting to emulsification and chain extension reaction after neutralization to obtain emulsion particles with fine core-shell structures based on the understanding that the embodiments for introducing the block isocyanate into the aqueous dispersion resin though the blocking of the nonionic polar groups containing polyisocyanate has the closest relevancy.

That is to say, the primary invention according to the present inventions relates to an emulsion composition prepared by: synthesizing carboxyl group containing isocyanate-terminated urethane prepolymer in the reaction mixture where nonionic polar group containing blocked polyisocyanate is generated to make use of the nonionic polar group containing blocked polyisocyanate together with the carboxyl group containing isocyanate-terminated urethane prepolymer, thereby forming a core component (core part) from the nonionic polar group containing blocked polyisocyanate and a shell (shell part) from the polyurethane resin that is produced by neutralization and chain extension of the carboxyl groups containing isocyanate-terminated urethane prepolymer, as exemplarily shown in FIG. 1. (a).

More particularly, the primary invention according to the group of the present inventions, relates to a blocked isocyanate containing emulsion composition prepared by; reacting organic polyisocyanate (a1) with nonionic polar group containing high molecular weight polyol (a2) thereafter blocking isocyanate groups with a blocking agent (C) to form a blocked polyisocyanate component (A); subsequently reacting, in the above reaction mixture, organic polyisocyanate (b1), high molecular weight polyol (b2), and anionic low molecular weight glycol containing a carboxyl group (b3) to form carboxyl group containing isocyanate-terminated urethane prepolymer (B); neutralizing carboxyl groups in aforementioned reaction mixture by a neutralizing agent (D); then emulsifying resulted reaction mixture in water; and further then subjecting resulted emulsion to chain extension reaction by a chain extension agent to prepare a highly crosslinkable polyurethane resin.

And, the blocked isocyanate containing emulsion composition with particle size distribution of the aqueous emulsion from 50 to 150 nm and with an weight ratio of core/shell from 50/50 to 70/30 reduces the particle size distribution of the emulsion so that the aqueous dispersibility and the storage stability thereof at the temperature not less than 35 degrees Celsius may sufficiently improved and the coating performances such as strength and uniformity appearing around the dissociation temperature of the blocking groups may be enhanced.

As an optional feature or preferable embodiment according to the group of the present inventions, the high-molecular weight polyol (b2) may have a carbonate skeleton or a phthalate-skeleton, the neutralizing agent may be an amine compound, and the chain extension agent may be a polyamine compound, and the emulsion composition may be an aqueous baking one-component type emulsion. Furthermore, a production method of the blocked isocyanate containing emulsion composition according to the present inventions has a primary aspect which includes the steps of: forming a blocked polyisocyanate component (A); subsequently reacting, in the above reaction mixture, organic polyisocyanate (b1), high molecular weight polyol (b2), and anionic low molecular weight glycol containing a carboxyl group (b3) to form carboxyl group containing isocyanate-terminated urethane prepolymer (B), as described in paragraph 0009; The main usage of the blocked isocyanate containing emulsion composition according to the present inventions, may be an aqueous one-component coating composition that contains the blocked isocyanate containing emulsion composition as a curing agent, and a polyurethane based resin as a primary agent.

Here, providing the comparison between the present inventions and the prior arts, it is clearly distinguished by referencing each of Patent Literatures herein described in the paragraphs from 0003 to 0005 as the background arts as well as other Patent Literatures that the present inventions get ahead of the previous improvement methods for the blocked isocyanate containing emulsion composition; when considering the prior invention of the Patent Literature 4 and 5, the present inventions make the emulsions particle size distribution narrower, the aqueous dispersibility as well as the storage stability of the emulsion at the temperature not less than 35 degrees Celsius are improved sufficiently, and coating performance of various kind such as coating strength and coating uniformity is improved. Furthermore, any of the prior references fails to teach or suggest the primary aspect of the present inventions, which includes the steps of: generating blocked isocyanate through blocking of the nonionic polar group containing isocyanate; synthesizing the carboxyl group containing isocyanate-terminated urethane prepolymer in the above reaction mixture; and subjecting to emulsification and chain extension reaction after neutralization as well as the principal feature of the present inventions of providing the emulsion particles with fine core-shell structures.

Hereinbefore, since the present inventions have been summarized by means for solving the present problems in accordance with the circumstance to invent the present inventions as well as the primary configurations and features of the present invention: Here, overlooking throughout the present invention to clarify the entire of the present invention, the present inventions are composed of following group of invention units, in which the inventions [1] and [2] represent the primary inventions, and the inventions provided subsequently represent practical examples or practical embodiments for the primary inventions (the entire group of the inventions is herein referred to as “the present inventions”).

[1] The blocked isocyanate containing emulsion composition prepared by; reacting organic polyisocyanate (a1) with nonionic polar group containing high molecular weight polyol (a2) thereafter blocking isocyanate groups with a blocking agent (C) to form a blocked polyisocyanate component (A); subsequently reacting, in the above reaction mixture, organic polyisocyanate (b1), high molecular weight polyol (b2), and anionic low molecular weight glycol containing a carboxyl group (b3) to form carboxyl group containing isocyanate-terminated urethane prepolymer (B); neutralizing carboxyl groups in aforementioned reaction mixture by a neutralizing agent (D); then emulsifying resulted reaction mixture in water; and further then subjecting resulted emulsion to chain extension reaction by a chain extension agent to prepare a highly crosslinkable polyurethane resin.

[2] The blocked isocyanate containing emulsion composition of [1], aforementioned emulsion composition having a core-shell structure in which aforementioned blocked polyisocyanate component (A) forms a core part and aforementioned highly crosslinkable polyurethane resin forms a shell part.

[3] The blocked isocyanate containing emulsion composition of [1] or [2], wherein the aqueous dispersed particle size distribution of the emulsion is ranging from approximately 50 to 150 nm, and the weight ratio of core/shell is ranging from approximately 50/50 to 70/30.

[4] The blocked isocyanate containing emulsion composition of any one of [1] to [3], wherein aforementioned high molecular weight polyol (b2) has a carbonate skeleton or a phthalate skeleton.

[5] The blocked isocyanate containing emulsion composition of any one of [1] to [4], wherein aforementioned neutralizing agent is an amine compound, and aforementioned chain extension agent is a polyamine compound.

[6] The blocked isocyanate containing emulsion composition of any one of [1] to [5], wherein aforementioned emulsion composition is an aqueous baking one-component type emulsion.

[7] The production method of the blocked isocyanate containing emulsion composition of any one of [1] to [6], aforementioned method comprising the steps of: reacting organic polyisocyanate (a1) with nonionic polar group containing high molecular weight polyol (a2) thereafter blocking isocyanate groups with a blocking agent (C) to form a blocked polyisocyanate component (A); subsequently reacting, in the above reaction mixture, organic polyisocyanate (b1), high molecular weight polyol (b2), and anionic low molecular weight glycol containing a carboxyl group (b3) to form carboxyl group containing isocyanate-terminated urethane prepolymer (B); neutralizing carboxyl groups in aforementioned reaction mixture by a neutralizing agent (D); then emulsifying resulted reaction mixture in water; and further then subjecting resulted emulsion to chain extension reaction by polyamine to prepare a highly crosslinkable polyurethane resin.

[8] The aqueous one-component coating composition that contains the blocked isocyanate containing emulsion composition of any one of [1] to [6] as a curing agent, and a polyurethane based resin as a primary agent.

[9] The aqueous one-component baking paint composition that contains the blocked isocyanate containing emulsion composition of any one of [1] to [6] as a curing agent, and a polyurethane based resin as a primary agent.

[10] The aqueous one-component baking adhesive composition that contains the blocked isocyanate containing emulsion composition of any one of [1] to [6] as a curing agent, and a polyurethane based resin as a primary agent.

### TECHNICAL ADVANTAGE OF THE INVENTION

According the present inventions, in the blocked isocyanate containing emulsion composition, the emulsion particles are provided with fine core-shell structures to make the emulsion particle size distribution narrower, and then (i) the homogeneous emulsion without impurity is obtained, (ii) the aqueous dispersibility and the storage stability of the emulsion at the temperature not less than 35 degrees Celsius are improved sufficiently (iii) various coating performances appearing around the dissociation temperature of the blocking groups, such as coating strength, coating uniformity and an outward appearance thereof are improved so that the blocked isocyanate containing emulsion composition may be quite useful as an organic solvent-free aqueous paint or adhesion agent.

Furthermore, the aqueous emulsion composition according to the present inventions (iv) is capable of forming a uniform film without influence from environmental temperature and (v) provides with excellent environmental preservation property, excellent working safety as well as excellent handling property because of the aqueous nature thereof. Also, the aqueous emulsion composition of the present inventions (vi) has high productivity due to the simple production process thereof, and (vii) exhibits excellent miscibility with primary agents of coating agents such as polyurethane resins and modified polyolefin resins.

### BEST MODE FOR CARRYING OUT THE INVENTION

The present inventions have been set forth along with the primary configurations of the present invention depending on means for solving the problems. Hereinafter, further detailed embodiment according to the present invention of the above group of the inventions will be detailed.

1. With Respect to Blocked Isocyanate Containing Emulsion Composition

### (1) Blocked Isocyanate Containing Emulsion Composition

The blocked isocyanate containing emulsion composition as the primary invention of the invention group is the improvement about the aqueous one component type polyurethane coating agent that uses the blocked isocyanate compound and is featured as an aqueous emulsion in highly crosslinkable self-dispersed type which includes thermal-dissociable type blocked isocyanates.

In the aforementioned aqueous one-component type coating polyurethane emulsion described in the paragraph 0006 as prior invention, which is prepared by mixing the non-anionic (nonionic) polyisocyanate with the carboxyl group containing isocyanate-terminated urethane prepolymer; blocking the isocyanate groups of the mixture by the blocking agent; neutralizing the carboxyl groups in the mixture; emulsifying the mixture in water; and subjecting the obtained mixture to chain extension reactions by the diamine, since the blocked isocyanates were introduced into the aqueous-dispersed resin beforehand, the amounts of the isocyanate groups being effective during the thermal dissociation was restricted such that the aqueous dispersability and the storage stability of the emulsion at the temperature not less than 35 degrees Celsius were not still sufficient. In turn, the present inventions has been developed the above previous aqueous one-component type coating polyurethane emulsion further to improve the aqueous dispersability and the emulsion's storage stability as well as to enhance various coating performances appearing around the dissociation temperature of the blocking groups.

In the prior art, when the thermally dissociative blocked isocyanate is prepared to paints or adhesive, almost of the main ingredients has high viscosity such that the aqueous dispersibility and the handling performance thereof are poor. In addition, when the ratio of the blocked isocyanate is increased for performance improvement, the emulsion becomes separated at the temperature not less than 35 degrees Celsius, because the nonionic hydrophilic groups become a major ingredient. Furthermore, film formability and outward appearance are likely to degrade due to repellent of coating and phase separation. Furthermore, the composition in which blocked isocyanate groups are introduced into the aqueous dispersive type resin beforehand has the aspects in which the amount of isocyanate groups being effective during thermal dissociation is restricted and the aqueous dispersability and a storage stability of the emulsion at the temperature not less than 35 degrees Celsius are insufficient such that the coating performance could not be insufficient and design flexibility as compositions for coatings or adhesives could be narrower. Then, the present invention may also overcome the above problems of the conventional art.

Therefore, the present inventions primarily based on: synthesizing carboxyl group containing isocyanate-terminated urethane prepolymer in situ in the reaction mixture where nonionic polar group containing blocked polyisocyanate is generated, and after the neutralization thereof emulsifying and extending the chain thereof in order to use the nonionic polar group containing blocked polyisocyanate together with the carboxyl group containing isocyanate-terminated urethane prepolymer as the main feature.

More particularly, the blocked isocyanate containing emulsion composition is prepared by: reacting organic polyisocyanate (a1) with nonionic polar group containing high molecular weight polyol (a2) thereafter blocking isocyanate groups with a blocking agent (C) to form a blocked polyisocyanate component (A); subsequently reacting, in situ, in the above reaction mixture, organic polyisocyanate (b1), high molecular weight polyol (b2), and anionic low molecular weight glycol containing a carboxyl group (b3) to form carboxyl group containing isocyanate-terminated urethane prepolymer (B); neutralizing carboxyl groups in aforementioned reaction mixture by a neutralizing agent (D); then emulsifying resulted reaction mixture in water; and further then subjecting resulted emulsion to chain extension reaction by a chain extension agent to prepare a highly crosslinkable polyurethane resin.

### (2) Core-Shell Structure in the Emulsion Composition

As described in the paragraphs 0007 to 0008, the blocked isocyanate containing emulsion composition of the present inventions is primarily characterized in that the emulsion includes fine core-shell structures (that is to say, almost nano-capsules) such that the nonionic polar group containing blocked polyisocyanate forms the core components (core part) while the strong flexible highly crosslinkable anionic polyurethane resin that is obtained by neutralization and chain extension of the carboxyl groups containing isocyanate-terminated urethane pre-polymer forms the shell components (shell part) to provide the stably dispersed emulsion composition as shown in FIG. 1. (a).

The blocked isocyanate containing emulsion composition, in which the aqueous dispersed particle size distribution of the emulsion ranges from 50 to 150 nm and in which the weight ratio of core/shell ranges from 50/50 to 70/30, has the narrow emulsion particle size distribution such that the aqueous dispersibility as well as the storage stability thereof at temperature not less than 35 degrees Celsius are sufficiently improved and the prevention of phase separation over long term is attained. Furthermore, the coating performances appearing around the dissociation temperature of the blocking groups, such as coating strength, coating uniformity, outward appearance, etc. are improved and an uniform film may be prepared without influence from environmental temperature while having excellent immiscibility with the primary coating agent such as polyurethane resins and modified polyolefin resins.

As for the comparison, as exemplarily illustrated in FIG. 1 (b), the situation corresponding to the prior invention set forth in the paragraph 0006 herein is shown, where the nonionic polar group containing blocked polyisocyanate dispersion forms core components, and the polyurethane resins produced by neutralization and chain extension of the carboxyl groups containing isocyanate-terminated urethane prepolymer are adhered partially around the core component.

### (3) The Properties of the Core-Shell Structures

According to the granularity (particle size) distribution measurement, the emulsion composition having the core-shell structure of the present invention was found to form an impurity-free homogeneous emulsion and to consist an additional feature of the present inventions. This novel feature has been explained as the advantage (i) in the paragraph 0014.

More particularly, FIG. 2 shows the results of the granularity distribution measurement of the emulsion composition according to present invention, as the graph of granularity (micro-meter) versus frequency (percentage); MICROTRAC HRA/VSR MODEL No. 9 320X100 (manufactured by Leeds and Northrup Corp.) as a measurement instrument and pure water as a solvent were used.

As the comparative example, FIG. 3 shows the results of the measurements of granularity distribution of the admixed emulsion of the nonionic polar group containing blocked polyisocyanate dispersion (corresponding to the core component) and the polyurethane resin (corresponding to the shell part) produced by neutralization and chain extension from the carboxyl group containing isocyanate-terminated urethane prepolymer. Similarly, FIGS. 4 and 5 show, as comparative examples, the results of the measurements of the granularity distributions of solo core and solo shell parts, respectively.

As clearly understood by comparison of each of figures, the emulsion of the present invention shown in FIG. 2 shows the homogeneous particle size distribution, and there is no particle size distribution indicating the presence of impurity. In the comparative examples shown in FIGS. 3-5, the distribution of some impurity particle other than the emulsion particles were acknowledged at the larger particle size region.

### (4) Ingredient Materials for the Blocked Polyisocyanate Containing Emulsion Composition

(i) Organic Polyisocyanate (a1) and (b1)

The organic polyisocyanates (a1) and (b1) used in the process for preparing the blocked polyisocyanate component (A) and the carboxyl group containing isocyanate-terminated urethane prepolymer (B) may preferably include organic diisocyanates. Such organic diisocyanates may include, but not limited thereto, any conventional ingredients for polyurethane resin. In order to avoid film yellowing due to UV light, aliphatic or cycloaliphatic diisocyanates may be more preferable rather than aromatic diisocyanates.

To avoid complicated descriptions and also to provide the essential descriptions for simplifying the description, the following exemplary explanation for each of compounds may be simplified, however, such simplification does provide no influence on the essential parts of the present invention.

Particularly, the aliphatic diisocyanate may include, such as, for example, tetramethylene diisocyanate, hexamethylene diisocyanate, lysine diisocyanate, 2-methylpentane-1,5-diisocyanate, 3-methylpentane-1,5-diisocyanate, 2,2,4-trimethylhexamethylene-1,6-diisocyanate, and 2,4,4-trimethylhexamethylene-1,6-diisocyanate. Aromatic diisocyanate may include, such as, for example, isophorone diisocyanate, cyclohexyl diisocyanate, hydrogenated xylylene diisocyanate, hydrogenated diphenylmethane diisocyanate, hydrogenated trimethyl xylylene diisocyanate. These diisocyanates may be used solely or used in any admixture of more than two species.

Furthermore, the diisocyanate may include, such as, for example, adduct modified, carbodiimide modified, allophanate modified biuret modified, uretodione modified, uretoimine modified, and/or isocyanurate modified diisocyanates, more particularly, may include, for example, allophanate-modified diisocyanates obtained form hexamethylene diisocyanate and mono-ol with from 1 to 6 carbon atoms.

In consideration of the durability and the adherence of coatings formed from the aqueous polyurethane emulsion obtained by the present inventions, the base polyisocyanate for the nonionic polar group containing polyisocyanate may preferably include isocyanurate modifications and complex-modifications prepared from aliphatic diisocyanates and/or cycloaliphatic diisocyanates.

The aromatic diisocyanates may include, such as, for example, 2,4-tolylene diisocyanate, 2,6-tolylene diisocyanate, xylene-1,4-diisocyanate, xylene-1,3-diisocyanate, 4,4′-diphenylmethane diisocyanate, 2,4′-diphenylmethane diisocyanate, 4,4′-diphenyl ether diisocyanate, 2,2′-diphenylpropane-4,4′-diisocyanate, 3,3′-dimethyldiphenylmethane-4,4′-diisocyanate, m-phenylene diisocyanate, p-phenylene diisocyanate, naphthylene-1,4-diisocyanate, etc.

(ii) Nonionic Polar Group Containing High Molecular Weight Polyol (a2)

The high molecular weight polyol used in the process for forming the blocked polyisocyanate may include, such as, for example, polyols which contain nonionic polar group to give the blocked polyisocyanate a hydrophilic nature. For examples, polyalkylene polyols that contain usual polar alkoxy groups as the nonionic polar groups may be available.

Of course, usual nonionic polar group containing polyester polyols and polycarbonate-polyols may be also available.

The part for the high molecular weight polyol may preferably have their number-averaged molecular weight from 500 to 10,000, and more preferably from about 500 to 5,000.

(iii) Blocking Agent (C)

The blocking agent (C) used in the present invention is not limited particularly, and may be appropriately selected at least one compound from known compounds. The blocking agents may include, such as, for example, phenol group compounds, alcohol group compounds, active methylene group compounds, mercaptan group compounds, acid amid group compounds, lactam group compounds, acid imide group compounds, imidazole group compounds, urea group compounds, oxime group compounds, amine group compounds, etc.

More particularly, the phenol group compounds may include, such as, for example, phenol and cresol, ethylphenol; the alcohol group compounds may include such as propylene glycol monomethyl ether, ethylene glycol, benzylalcohol, methanol and ethanol; the active methylene group compounds may include such as dimethyl malonate and acetylacetone; the mercaptan group compounds may include such as butyl mercaptan and dodecyl mercaptan; the acid amid group compounds may include such as acetonitride and acetic acid amide; the lactam group compounds may include such as epsilon-caprolactam and delta-valerolactam; the acid imide group compounds may include such as succinic acid imide and maleic acid imide; the oxime group compounds may include such as acetaldoxime, acetone oxime and methyl ethyl ketoxime; the amine group compound may include such as diphenylaniline, aniline and ethyleneimine. In view of availability and working performance, the methyl ethylketoxime, epsilon-caprolactam and 2-ethylhexanol may be preferably used in the present invention among the aforementioned blocking agents.

(iv) High Molecular Weight Polyol (b2)

The high molecular weight polyol (b2) used in the process for preparing the carboxyl group containing isocyanate-terminated urethane prepolymer may include, such as, for example, polyester polyol, polyesteramide polyol, polyether polyol, polyether-ester polyol, polycarbonate polyol, polyolefin polyol that have normally a number average molecular weight from 500 to 10,000, more particularly, from 500 to 5,000, and any admixture thereof. Here, when considering the water durability of the shell part, the high molecular weight polyols having carbonate skeletons or phthalate skeletons may be preferable.

The polyester polyols and the polyesteramide polyols may include, for example, those obtained through the reaction between any of the polycarboxylic acid derivatives such as polycarboxylic acids, acid esters, acid anhydrides or acid halides and any of low molecular weight polyol, low molecular weight polyamine or low molecular weight amino alcohol etc. with the number average molecular weight thereof being less than 500.

(v) Carboxyl Group Containing Anionic Low Molecular Weight Glycol (b3)

The carboxyl group containing anionic low molecular weight glycol (b3) used in the process for preparing the carboxyl group containing isocyanate-terminated urethane prepolymer, may be incorporated into the backbone of the prepolymer through the reaction of the active hydrogens of the hydroxyl groups at both terminals with the isocyanate groups so that the aqueous dispersibility of the prepolymer may be enhanced due to hydrophilic nature of the carboxyl group. The carboxyl group may provide further enhancement of the aqueous dispersibility through additional neutralization.

The carboxyl group containing low molecular weight glycol may include, such as, for example, dimethylol propionic acid and dimethylol butanic acid, which have two terminal hydroxyl groups, other reaction products prepared from polyamines with acid anhydrides, and lacton adducts obtained by using dimethylol propionic acid, dimethylol butanic acid or the like as an initiated agent.

### (vi) Neutralizing Agent

The neutralizing agent of the present invention may be optionally used and the neutralizing agent may include any conventional neutralizing agents. The neutralizing agent preferably may include, for example, organic amines such as ethylamine, trimethylamine, triethylamine, triisopropylamine, triethanolamine, triisopropanolamine, morpholine and N-methylmorpholine; and inorganic alkalis such as sodium hydroxide, potassium hydroxide and ammonia. In order to enhance climate resistance and water resistance of dried film, the neutralizing agent may preferably include volatile one that easily dissociates by heating, and amino alcohols reactive to polyisocyanate curing agents.

(vii) Chain Extension Agent

The chain extension agent may preferably include, but not limited thereto, diamime compounds and polyamine compounds in term of various physical properties such as water resistance, solvent resistance and pollution resistance because they lead to crosslinking highly and easily when compared with diol compounds as the chain extension agent. The amine compounds may include, for example, diamines such as ethylene diamine (EDA) and isophorone diamine (IPDA), and polyamines such as diethylenetriamine (DETA), triethylenetriamine, tetraethylenepentamine and pentaethylenehexamine, which are represented by the general formula: H₂N—(C₂H₄NH)ₙ—C₂H₄NH₂ (n=1 to 8).

(viii) Curing Catalysts and Curing Agents

A resin-formation catalyst (urethane-formation catalyst) as a curing catalyst (polymerization catalyst) for urethane reaction may be optionally used, if necessary. Conventional curing catalysts may be available and may include, for example, metal catalysts such as dibutyl tin dilaurate and zinc naphthenate, and amine catalysts such as triethylenediamine and N-methylmorpholine such that the reaction rate may increase and the reaction temperature may be lowered.

The curing agents for curing the polyurethane resin, may include trimers and adducts with more than three NCO groups in single molecule, that are derived from a hexamethylene diisocyanate (HDI) or a isophorone diisocyanate (IPDI).

2. Production Method of Blocked Isocyanate Containing Emulsion Composition

The production method of the blocked isocyanate containing emulsion composition according to the present inventions primary comprises the steps of: reacting organic polyisocyanate (a1) with nonionic polar group containing high molecular weight polyol (a2) thereafter blocking isocyanate groups with a blocking agent (C) to form a blocked polyisocyanate component (A); subsequently reacting, in situ in the reaction mixture, organic polyisocyanate (b1), high molecular weight polyol (b2), and anionic low molecular weight glycol containing a carboxyl group (b3) to form carboxyl group containing isocyanate-terminated urethane prepolymer (B); neutralizing carboxyl groups in the reaction mixture by a neutralizing agent (D); then emulsifying resulted reaction mixture in water; and further then subjecting resulted emulsion to chain extension reaction by a polyamine.

Particularly, in accordance with the primary aspect in which nonionic polar group containing isocyanate is blocked to form the blocked polyisocyanate and; and in situ in that reaction mixture, the carboxyl group containing isocyanate-terminated urethane prepolymer is synthesized; the emulsion particles form fine core-shell structures such that the aforementioned advantages (i) to (vii) of the present invention described in the paragraph 0014 are provided.

The blocking reaction may be carried at the temperature from 20 to 100 degrees Celsius, more preferably, from 30 to 90 degrees Celsius as the conventional condition for block reaction. At this time, any well-known urethane-formation catalysts may be used. The blocking ratio may be preferably not less than 20 mol-percent, more preferably, may range from 30 to 50 mol-percent.

When the blocking ratio was too low, the strength and durability of the film tends to become insufficient.

Any known urethane-formation catalysts may be allowed to use during the production process of the carboxyl group containing isocyanate-terminated urethane prepolymer. The reaction temperature may preferably range from 0 to 100 degrees Celsius, more preferably, from 20 to 90 degrees Celsius. At this time, diluting into any solid contents by any organic solvent that is substantially inactive to isocyanate group may be preferable in terms of mixing efficiency. The organic solvents may include, for example, aromatic solvents such as toluene and xylene; aliphatic hydrocarbon solvents such as hexane; cycloaliphatic solvents such as cyclohexane and isophorone; ketone solvents such as acetone and methyl ethyl ketone; ester solvents such as ethyl acetate and butyl acetate; glycol ether ester solvents such as ethylene glycol monoethyl ether acetate and propylene glycol mono-methyl ether acetate; glycol ether solvents such as ethylene glycol dimethyl ether diethylene glycol dibutyl ether and propylene glycol dibutyl ether.

Neutralization may be carried out by using various neutralizing agents described in paragraph 0031, under usual neutralization reaction condition that ranges from 20 to 50 degrees Celsius.

3. Aqueous Polyurethane Resin Emulsion Coating Composition

### (1) Primary Agent and Curing Agent

The aqueous polyurethane resin coating composition according to the present invention corresponds to applied embodiments originated from the primary invention of the present inventions, and may be used for coating agents (paints) and adhesive agents. The aforementioned coating composition may be primary composed from a primary agent and a curing agent, the block isocyanate containing emulsion composition may be used as the curing agent, and any conventional polyurethane resins or modified polyolefin resins may be used as the primary agent, appropriately.

### (2) Embodiments of Practical Use

After applied on any one of various conventional substrates such as metals, plastics, woody materials and inorganic materials as a coating agent, the aforementioned coating composition could be cured and baked thereon by heating of the coated film, in which the blocking groups dissociates so that isocyanate groups undergo cross-linking reaction with active hydrogens highly.

### (3) Additives

In order to enhance various physical properties even more, and to give some additional physical properties other than the aforementioned physical properties, some of the optional additives may be available. The optional additives may include anti-flammable agents, plasticizer agents, antioxidant agents, UV ray absorbing agents, dyes, pigments, fillers, internal de-molding agents, reinforcing agents, matting agents, electronic conductivity importing agents, charge control agents, antistatic agents, lubricants and other processability-enhancing additives.

### EXAMPLES

Hereinafter, the present inventions will be practically described in detail to clarify the feature of the present inventions by examples while comparing with comparative examples, and the rationality and the significance of the each features of the present invention as well as the excellence thereof compared to the conventional arts will be demonstrated.

Production Process of the Blocked Isocyanate Containing Emulsion Composition

The organic polyisocyanate (a1) was subjected to the reaction with the nonionic polar group containing high-molecular weight polyol (a2); thereafter the isocyanate groups were blocked by the blocking agent (C) to form the blocked polyisocyanate component (A); subsequently, in situ in the above reaction mixture, the organic polyisocyanate (b1), the high-molecular weight polyol (b2) and the carboxyl group containing anionic low-molecular weight glycol (b3) were reacted to prepare the carboxyl group containing isocyanate-terminated urethane prepolymer (B); then the carboxyl groups in the reaction mixture were neutralized by the neutralization agent (D); after that, the resulted reaction mixture was emulsified in water; and further the resulted emulsion was subjected to a chain extension reaction by polyamine.

(The Naming of the Components)

Isocyanate A: Isophorone diisocyanate/NCO=37.8 percent
Isocyanate B: HDI trimer type polyisocyanate/NCO=21.2 percent
Isocyanate C: HDI allophanate type polyisocyanate/NCO=19.4 percent
Polyol A: 1,6-Hexanediol-based polycarbonate diol/OH value=56 mg KOH/g
Polyol B: Methoxy polyethylene glycol/OH value=81 mg KOH/g
Low molecular weight glycol: Trimethylolpropane/OH value=1,254 mg KOH/g
Anionic hydrophilic group component: Dimethylol propionic acid/OH value=837 mg KOH/g
Organic amine component: Diethylenetriamine (supplied by Kishida Chemical Co., Ltd.)/NH value=1,631 mg KOH/g
Neutralizing agent: Triethylamine (supplied by Kishida Chemical Co., Ltd.)
Blocking agent: MEK oxime (supplied by Mitsubishi Gas Chemical Company, Inc.)
Solvent A: Dipropylene glycol dimethyl (supplied by Nippon Nyukazai Co., Ltd.)
Solvent B: Diethylene glycol diethyl (supplied by Nippon Nyukazai Co., Ltd.)
Urethane-formation Catalyst: Dioctyltin laurate (supplied by Katsuta Kako K.K.)

(The Synthesis Example of the Blocked Isocyanate Containing Emulsion)

In a four-necked 1-L separable flask equipped with a stirrer having anchor type fans, a thermometer and a condenser, 158 g of the isocyanate B, 26.0 g of the polyol B, 27.8 g of the solvent B and 0.001 g of the urethane-formation catalyst were charged and were heated at 85 degrees Celsius for 2 to 3 hours with stirring to cause the urethane reaction. Then, the reaction mixture was cooled while keeping its temperature between 80 and 40 degrees Celsius. The blocking agent of 66.0 g was charged in a dropping funnel and was dropped into the reaction mixture over a period of 30 minutes to 1 hour. Then, the reaction mixture was subject to the reaction at 70 to 80 degrees Celsius for additional 2 hours to complete the reaction. After that, the NCO content therein was measured to confirm that the measured value was not more than 0.1 weight-percent.

Thereafter, to the resulted blocked isocyanate intermediate, 115 g of the polyol A, 1.2 g of the low molecular weight glycol, 7.6 g of the anionic hydrophilic group component and 50 g of the solvent A were added and dissolved with stirring at 80 to 90 degrees Celsius for 1 hour. After being cooled to the 70 to 80 degrees Celsius, 40.3 g of the isocyanate A was added and subjected to the reaction with stirring at 80 to 90 degrees Celsius for 3 hours. After confirming that the hydroxyl groups and the isocyanate groups were reacted equivalently, the product was cooled to 50 to 60 degrees Celsius followed by addition 8.2 g of the isocyanate B. After stirring for approximately 30 minutes, 5.8 g of the neutralizing agent was added, the stirring was continued for approximately 30 minutes at 50 to 60 degrees Celsius.

Into the liquid mixture, 450 g of room temperature water was dropped with stirring at 300 rpm over a period of 2 minutes. At 30 minutes after the completion of the dispersion, 21 g of room temperature 15 percent aqueous solution of organic amine prepared beforehand was dropped. High speed stirring was kept for 1 hour to obtain milky white target material. Then, the stirring speed was reduced to normal rate (about 100 rpm) and the stirring was continued at 50 to 60 degrees Celsius for additional 2 hours.

By using FT-IR, the absence of peaks originated from the NCO residue was confirmed. The resulted non-volatile residue of the target material was 43 percent with a viscosity of 63 mPa s (at 25 degrees Celsius) and an average dispersed particle size of 136 nm.

(The Production Examples of the Aqueous Polyurethane Resin Emulsion Coating Composition)

100 g of an aqueous polyurethane dispersion A (polycarbonate based non-yellowing type with viscosity of 60 mPa s (at 25 degrees Celsius), non-volatile residue of 35 weight-percent and average dispersed particle size of 60 nm, supplied by Nippon Polyurethane Industry co., Ltd.), 50 g of the aforementioned obtained target emulsion and 0.15 g of the leveling agent (POLYFLOW KL 280 supplied by Kyoeisha Chemical Co., Ltd) were mixed at room temperature by using a mixer to obtain the coating compositions. Table 1 summarizes the results of the production examples.

TABLE 1

| | | | | | Comparative | Comparative |
|---|---|---|---|---|---|---|
| | Example A | Example B | Comparative A | Comparative B | C | D |
| | New curing | New curing | Cold | Curing agent | Urethane | Urethane |
| | agent | agent | blend | aqueous dispersion | main agent | main agent |
| (Shell resin) | | | | | | |
| Isocyanate A | 40.3 | 40.3 | 20.3 | | 40.3 | |
| Polyol A | 114.7 | 114.7 | 57.3 | | 114.7 | |
| Low molecular weight glycol | 1.15 | 1.15 | 0.57 | | 1.15 | |
| Anionic hydrophilic group component | 7.6 | 7.6 | 3.8 | | 7.6 | |
| Isocyanate B | 8.2 | 8.2 | 4.1 | | 8.2 | |
| Organic amine | 3.15 | 3.15 | 1.57 | | 3.15 | |
| Neutralizing agent | 5.75 | 5.75 | 2.87 | | 5.75 | |
| Solvent A | 50 | 50 | 37.5 | 0 | 75 | 75 |
| Sum of solid contents | 175.1 | 175.1 | 87.6 | 0 | 175.1 | 175.1 |
| (Core Blocked isocyanate) | | | | | | |
| Isocyanate C | 163.3 | | | | | |
| Isocyanate B | | 158.0 | 79.0 | 158.0 | | |
| Polyol B | 24.1 | 26.0 | 13.0 | 26.0 | | |
| Blocking Agent | 62.5 | 66.0 | 33.0 | 66.0 | | |
| Urethanization Catalyst | 0.001 | 0.001 | 0.001 | 0.001 | | |
| Solvent B | 27.8 | 27.8 | 0.0 | 0.0 | 0 | 0 |
| Sum of solid contents | 249.9 | 250.0 | 125.0 | 250.0 | 0 | 0 |
| Water | 469.3 | 469.3 | 250.0 | 250.0 | 250 | 250 |
| Core/Emulsion resin | 0.588 | 0.588 | 0.588 | 1.00 | 0 | 0 |
| Effective NCO in the core solid contents | 8.2 | 12.8 | 12.8 | 12.8 | 0 | 0 |
| (%) | | | | | | |
| Solid contents of the emulsion resin (%) | 43.7 | 43.7 | 42.5 | 50.0 | 35.0 | 35.0 |
| Effective NCO in the emulsion resin's | 4.8 | 7.5 | 7.5 | 12.8 | 0.0 | 0.0 |
| solid content | | | | | | |
| Vis (mPa · s@25° C.) | 120 | 63 | 60 | 105 | 30 | 30 |
| Emulsion's average particle size (nm)*1 | | 136 | 188 | 165 | 120 | |
| Maximum particle size (nm) | | 289 | 486 | 409 | 204 | |
| Minimum particle size (nm) | | 79 | 111 | 94 | 66 | |
| 50° C./1 week Appearance of liquid | Good | Good | precipitation | 2 phase separation | Good | Good |

The Evaluation Tests of the Coating Agents

A steel plate (SPCC-SB supplied by Paltec Test Panels Co., ltd.) was applied with 100 micro-meter in wet by using an applicator, and after drying at room temperature for 5 minutes, and the coated film was further dried in a temperature-gradient oven (gradient-oven manufactured by BYK Gardner) at 100 to 200 degrees Celsius for 30 minutes.

(Outward appearance observations) The outward appearances of the coated films, each of which was obtained by drying/baking at each temperature described in Table 2, were visually inspected, and evaluated whether there was any tuck, whether mat or clear and whether there was any roughness and the like.

(Pencil hardness tests) Pencil hardness which gave scratches to the dried and baked coating film obtained at each temperature of Table 2 was examined and proved.

(MEK rubbing tests) In each coated film that was obtained by dried/baked at each temperature of Table 2, a cotton swab which were soaked slightly with methyl ethyl ketone (MEL) was moved reciprocally on the coated film, numbers of round trips just before the coated film was worn off or peeled off were measured.

(Water resistance tests) After each coated film which was obtained by dried/baked at each temperature of Table 2, was immersed in boiling water for 12 hours, the outward appearance thereof was inspected visually, and the good outward appearance was marked by a circle mark and bad outward appearance was evaluated by a cross mark, respectively.

Table 2 summarizes the results of the evaluation tests of the coating agents.

TABLE 2

| | Composition 1 | Composition 2 | Composition 3 | Composition 4 | Composition 5 | Composition 6 | Composition 7 |
|---|---|---|---|---|---|---|---|
| Example A of Table 1 | 100 | | | | | | |
| Example B of Table 1 | | 100 | 50 | 50 | | | |
| Comparative C of Table 1 | | | 100 | | 100 | 100 | 100 |
| Comparative D of Table 1 | | | | 100 | | | |
| Comparative B of Table 1 | | | | | | 100 | 50 |
| Outward appearance | | | | | | | |
| 100° C. | tuck | tuck | Clear | Clear | Clear | tuck | Clear |
| 110 | tuck | tuck | Clear | Clear | Clear | tuck | Clear |
| 120 | tuck | tuck | Clear | Clear | Clear | tuck | Clear |
| 130 | mat | mat | Clear | Clear | Clear | tuck | Clear |
| 140 | mat | mat | Clear | Clear | Clear | rough | Clear |
| 150 | mat | mat | Clear | Clear | Clear | rough | Clear |
| 160 | mat | mat | Clear | Clear | Clear | rough | Clear |
| 170 | mat | mat | Clear | Clear | Clear | rough | Clear |
| 180 | mat | mat | Clear | Clear | Clear | rough | Clear |
| 190 | mat | mat | Clear | Clear | Clear | rough | Clear |
| 200 | mat | mat | Clear | Clear | Clear | rough | Clear |
| Pencil hardness (scratch) | | | | | | | |
| 100° C. | <6B | <6B | <6B | <6B | <6B | <6B | <6B |
| 110 | <6B | <6B | <6B | <6B | <6B | <6B | <6B |
| 120 | <6B | <6B | <6B | <6B | <6B | <6B | <6B |
| 130 | <6B | <6B | <6B | <6B | <6B | 4B | <6B |
| 140 | 4B | <6B | <6B | <6B | <6B | 4B | <6B |
| 150 | B | 2B | <6B | <6B | <6B | 4B | <6B |
| 160 | B | 2B | <6B | <6B | <6B | 3B | <6B |
| 170 | B | B | <6B | <6B | <6B | 2B | <6B |
| 180 | B | 2B | <6B | <6B | <6B | 2B | <6B |
| 190 | B | 2B | <6B | <6B | <6B | 2B | <6B |
| 200 | B | 2B | <6B | <6B | <6B | 2B | <6B |
| MEK rubbing (wear out) | | | | | | | |
| 100° C. | 2 | 2 | 5 | 6 | 13 | 5 | 10 |
| 110 | 2 | 2 | 5 | 10 | 29 | 5 | 20 |
| 120 | 2 | 2 | 15 | 30 | 35 | 10 | 25 |
| 130 | 7 | 6 | 100 | >200 | 45 | 20 | 30 |
| 140 | 20 | 25 | >200 | >200 | 25 | 29 | 27 |
| 150 | 60 | 58 | >200 | >200 | 25 | 110 | 50 |
| 160 | 60 | 80 | >200 | >200 | 30 | 100 | 50 |
| 170 | 126 | 110 | >200 | >200 | 35 | 117 | 70 |
| 180 | 140 | >200 | >200 | >200 | 58 | 100 | 70 |
| 190 | 142 | >200 | >200 | >200 | 100 | >200 | 100 |
| 200 | 113 | >200 | >200 | >200 | 180 | >200 | >200 |
| Water resistance | | | | | | | |
| (appearance after boiling 12 h) | | | | | | | |
| 100° C. | X | X | X | X | X | X | X |
| 110 | X | X | X | X | X | X | X |
| 120 | X | X | ◯ | ◯ | X | X | X |
| 130 | X | X | ◯ | ◯ | ◯ | X | X |
| 140 | ◯ | ◯ | ◯ | ◯ | ◯ | X | X |
| 150 | ◯ | ◯ | ◯ | ◯ | ◯ | ◯ | ◯ |
| 160 | ◯ | ◯ | ◯ | ◯ | ◯ | ◯ | ◯ |
| 170 | ◯ | ◯ | ◯ | ◯ | ◯ | ◯ | ◯ |
| 180 | ◯ | ◯ | ◯ | ◯ | ◯ | ◯ | ◯ |
| 190 | ◯ | ◯ | ◯ | ◯ | ◯ | ◯ | ◯ |
| 200 | ◯ | ◯ | ◯ | ◯ | ◯ | ◯ | ◯ |

### The Considerations of the Results of the Examples and the Comparative Examples

As shown in Table 1, providing the comparison between the each of examples and each of comparative examples, it was indicated that the blocked isocyanate containing emulsion compositions (the examples A and B) of the present invention provided good liquid outward appearance and hence had excellent aqueous dispersibility even after one week under 50 degrees Celsius. In contrast, the comparative example B, that contained no polyurethane resin formed by subjecting the carboxyl group containing isocyanate-terminated urethane prepolymer to neutralization and chain extension, was found to cause two-phase separation; the comparative example A, that was cold blend resin of a component of the comparative example B and an urethane primary agent of the comparative example C, was found to cause precipitation; both of which lacked aqueous dispersibility.

As shown in Table 2, the blocked isocyanate containing emulsion compositions of either examples A or B (as shown composition 1 and composition 2, respectively) failed in exhibiting good coating performances such as outward appearance, pencil hardness, MEK rubbing, and water resistance, because they were not composed as the coating agent (paint) yet. The compositions 3 and 4 corresponding to the aqueous one-component type coating agent according to the present inventions, which were composed from the blocked isocyanate containing emulsion composition of the example B and the urethane primary agent of comparative examples C and D, respectively, were found to provided good coating film performances such as outward appearance, pencil hardness, MEK rubbing and water resistance. The compositions 5 to 7, each of which contained no blocked isocyanate containing emulsion composition of the present invention, were found to provide significantly poor coating film performances such as outward appearance, pencil hardness, MEK rubbing and water resistance when compared with that of the present inventions.

Hereinabove, from the comparison and the consideration of resulted data of each example and each comparative example, together with the consideration of the novel properties of the core-shell structures according to the present inventions, it may be concluded that the rationality and the significance of the features according to the present invention have been demonstrated and the present inventions have the remarkable excellence compared to the conventional arts.

### BRIEF DESCRIPTION OF THE DRAWINGS

FIG. 1 shows the schematic cross-sectional views of (a) the core-shell structure according to the present invention, and (b) the emulsion structure according to the comparative example A.

FIG. 2 is the graph showing the result of the granularity distribution of the emulsion composition according to present invention.

FIG. 3 is the graph showing the result of the granularity distribution of the admixed emulsion of the core component and the shell component.

FIG. 4 is the graph showing the result of the granularity distribution of the emulsion of only the core component.

FIG. 5 is the graph showing the result of the granularity distribution of the emulsion of only the shell component.

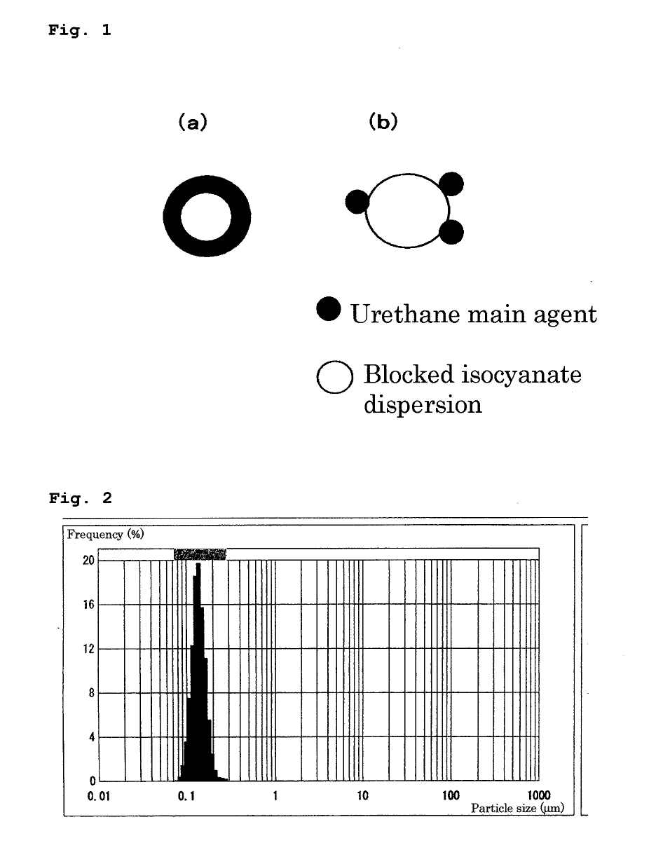

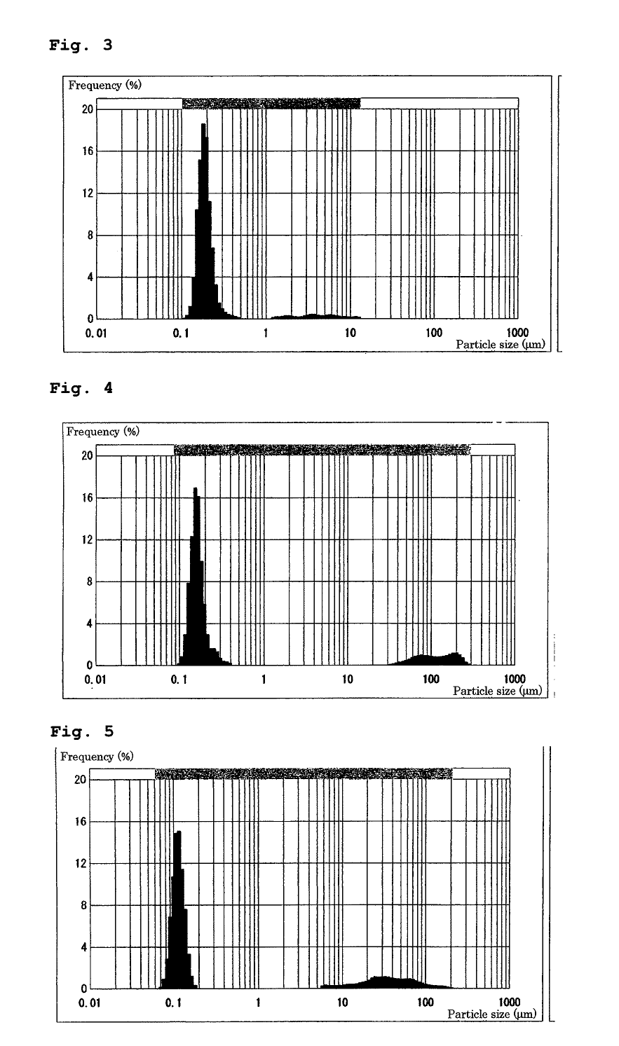

1. A blocked isocyanate containing emulsion composition prepared by;
reacting organic polyisocyanate (a1) with nonionic polar group containing high molecular weight polyol (a2) thereafter blocking isocyanate groups with a blocking agent (C) to form a blocked polyisocyanate component (A);
subsequently reacting, in the above reaction mixture, organic polyisocyanate (b1), high molecular weight polyol (b2), and anionic low molecular weight glycol containing a carboxyl group (b3) to form carboxyl group containing isocyanate-terminated urethane prepolymer (B);
neutralizing carboxyl groups in said reaction mixture by a neutralizing agent (D);
then emulsifying resulted reaction mixture in water;
and further then subjecting resulted emulsion to chain extension reaction by a chain extension agent to prepare a highly crosslinkable polyurethane resin.

2. The blocked isocyanate containing emulsion composition of claim 1, said emulsion composition having a core-shell structure in which said blocked polyisocyanate component (A) forms a core part and said highly crosslinkable polyurethane resin forms shell a part.

3. The blocked isocyanate containing emulsion composition of claim 1, wherein the aqueous dispersed particle size distribution of the emulsion is ranging from approximately 50 to 150 nm, and the weight ratio of core/shell is ranging from approximately 50/50 to 70/30.

4. The blocked isocyanate containing emulsion composition of claim 1, wherein said high molecular weight polyol (b2) has a carbonate skeleton or a phthalate skeleton.

5. The blocked isocyanate containing emulsion composition of claim 1, wherein said neutralizing agent is an amine compound, and said chain extension agent is a polyamine compound.

6. The blocked isocyanate containing emulsion composition of claim 1, wherein said emulsion composition is an aqueous baking one-component type emulsion.

7. A production method of the blocked isocyanate containing emulsion composition of claim 1, said method comprising the steps of:
reacting organic polyisocyanate (a1) with nonionic polar group containing high molecular weight polyol (a2) thereafter blocking isocyanate groups with a blocking agent (C) to form a blocked polyisocyanate component (A);
subsequently reacting, in the above reaction mixture, organic polyisocyanate (b1), high molecular weight polyol (b2), and anionic low molecular weight glycol containing a carboxyl group (b3) to form carboxyl group containing isocyanate-terminated urethane prepolymer (B);
neutralizing carboxyl groups in said reaction mixture by a neutralizing agent (D);
then emulsifying resulted reaction mixture in water;
and further then subjecting resulted emulsion to chain extension reaction by polyamine to prepare a highly crosslinkable polyurethane resin.

8. An aqueous one-component coating composition that contains the blocked isocyanate containing emulsion composition of claim 1 as a curing agent, and a polyurethane based resin as a primary agent.

9. An aqueous one-component baking paint composition that contains the blocked isocyanate containing emulsion composition of claim 1 as a curing agent, and a polyurethane based resin as a primary agent.

10. An aqueous one-component baking adhesive composition, wherein said aqueous one-component baking adhesive component contains the blocked isocyanate containing emulsion composition of claim 1 as a curing agent, and a polyurethane based resin as a primary agent.
